(19) United States
(12) Patent Application Publication
(10) Pub. No.: US 2007/0026740 A1
(43) Pub. Date: Feb. 1, 2007

(54) Adapter card structure

(75) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(73) Assignees: Power Digital Card Co., Ltd.; Chien-Yuan CHEN

(21) Appl. No.: 11/189,878

(22) Filed: Jul. 27, 2005

(51) Int. Cl. H01R 24/00

(52) U.S. Cl. 439/630

(57) ABSTRACT

An adapter card structure is used specifically for adapting a Mini SD/Micro SD card to an SD card. The adapter card is primarily composed of a hook at a side, which is formed integrally by an injection molding, so as to firmly latch the Mini SD/Micro SD card into the adapter card through the hook, upon inserting the Mini SD/Micro SD card into the adapter card, in order to prevent from a fall-off of the Mini SD/Micro SD card, reduce cost, and increase a productivity.

### BACKGROUND OF THE INVENTION

(a) Field of the Invention

The present invention relates to an adapter card structure, and more particularly to an adapter structure for adapting a Mini SD/Micro SD (Secure Digital) card to an SD card.

(b) Description of the Prior Art

A Memory card has become a new focus of existing storage media, which is provided with merits of small size and large capacity. In addition, a data transmission speed of the memory card is also very fast, which can perform data writing and reading at a speed of 10 MB per second.

There are many kinds of memory cards in the existing market, including an XD (extreme Digital Picture) card, an MMSD (Multi-Media Secure Digital) card, an SD card, an MMC (Multi-Media Card) card, a CF (Compact Flash) card, an MS (Memory Stick) card, and an SM (Smart Media) card. The primary differences among the aforementioned various types of memory cards are the storage format and the size.

However, when the memory card is performing data writing and reading, it should be through a connection with a card reader and an access device to achieve a purpose of data writing and reading. Accordingly, a three-in-one, a five-in-one, and a seven-in-one card readers are provided in the market to integrate all kinds of memory cards for performing data exchange through the card reader, so as to provide data writing and reading for many memory cards of different specifications by the multi-in-one card reader.

Although the multi-in-one card reader can provide data writing and reading for many memory cards of different specifications, there is still a kind of Mini SD/Micro SD card which cannot directly perform data transmission and exchange through the card reader and the access device, but have to adapt to a specification of an SD card through an adapter card, in order to perform data exchange and transmission through the card reader and the access device.

Referring to FIG. 1, a conventional adapter card 10 used for adapting a Mini SD card to an SD specification comprises a casing 11 on top covered with a metal piece 12, so as to form a slot 13 of a size of the Mini SD card 20 between the casing 11 and the metal piece 12, thereby enabling the Mini SD card 20 to be inserted into the slot 13 for accomplishing the adapting of the Mini SD card 20 to the SD specification.

Referring to FIG. 2, the Mini SD card 20 can be adapted to the SD specification when it is inserted into the adapter card 10. In the mean time, by a conduction effect between the Mini SD card 20 and a metal terminal 14 on the adapter card 10, data writing and reading can be performed between the Mini SD card 20 and an access device, through an insertion of the adapter card 10 on a card reader.

However, when the Mini SD card 20 is inserted into the adapter card 10, an extension arm 30 made of a metallic material (normally Copper) is further installed inside the adapter card 10 at a position corresponding to an edge of the slot 13 to avoid a fall-off of the Mini SD card 20. The extension arm 30 is formed by extending down the metal terminal 14 on the adapter card 30. A hook 31 is located on a tail end of the extension arm 30, so as to hook the Mini SD card onto a notch 21 at a side of the Mini SD card 20 upon inserting the Mini SD card 20 into the slot 13, thereby avoiding a fall-off of the Mini SD card 20.

However, as the extension arm 30 is formed by extending down the metal terminal 14, it will cause an inconvenience in manufacturing the metal terminal 14, and the metal terminal 14 should also be made into a small and thin shape, which is easily to be broken in assembling, thereby inducing an inconvenience in assembling, and increasing an imperfection rate and manufacturing cost of the product.

### SUMMARY OF THE INVENTION

The primary object of the present invention is to provide an adapter card structure wherein a hook formed integrally is located at a side of the adapter card to firmly latched an Mini SD/Micro SD card into the adapter card upon inserting the Mini SD/Micro SD card on the adapter card, in order to avoid a fall-off of the Mini SD/Micro SD card, thereby achieving functions of reducing manufacturing cost, increasing a productivity and a perfection rate of the product.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of inserting a Mini SD card into a conventional adapter card.

FIG. 2 shows a plan view of inserting a Mini SD card into a conventional adapter card.

FIG. 3 shows a schematic view before assembling an adapter card and a Mini SD card of the present invention.

FIG. 4 shows a schematic view after assembling an adapter card and a Mini SD card of the present invention.

FIG. 5 shows a plan view after assembling an adapter card and a Mini SD card of the present invention.

FIG. 6 shows a schematic view of another implementation of assembling a Micro SD card with an adapter card of the present invention.

FIG. 7 shows a perspective view of another implementation of a Micro SD card of the present invention.

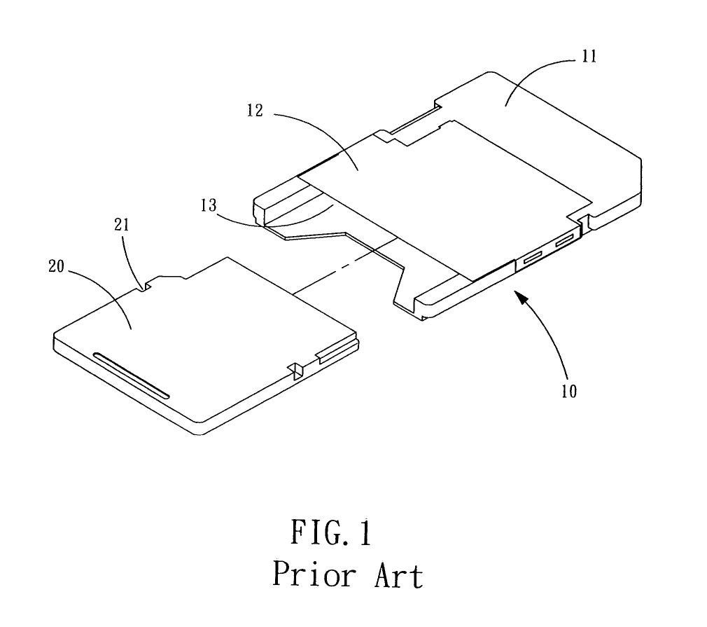

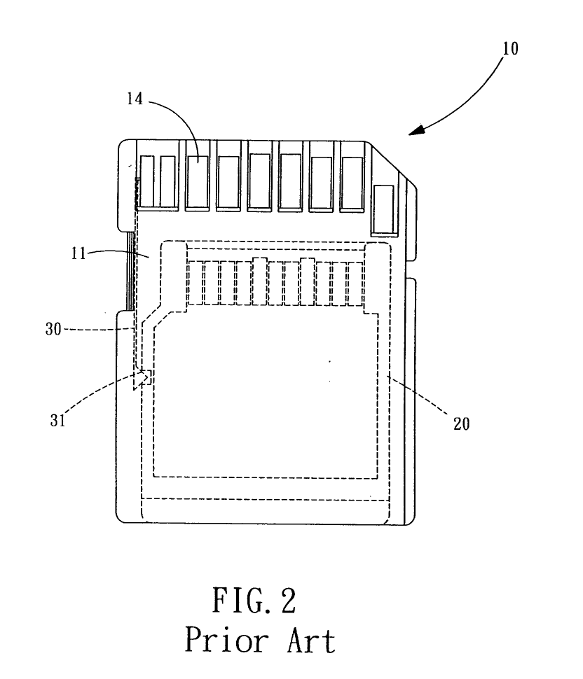

### DETAILED DESCRIPTION OF THE PREFERRED EMBODIMENTS

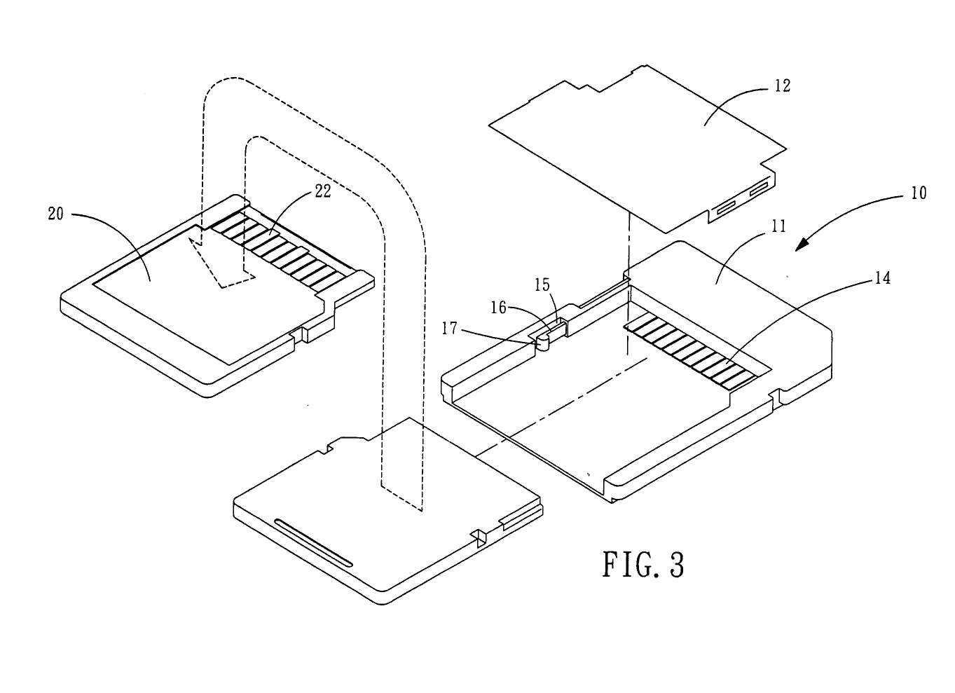

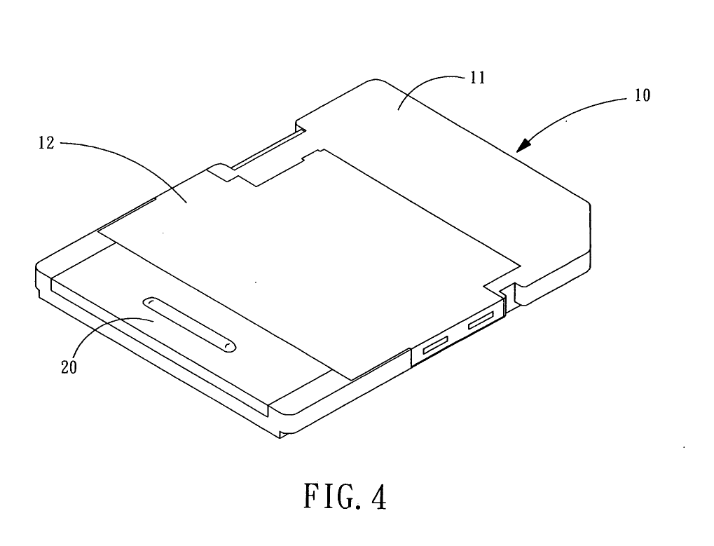

Referring to FIG. 3, an adapter card 10 of the present invention comprises primarily a casing 11, and a cover 12, wherein the cover 12 is covered on the casing 11, so as to form a slot 13 for inserting a Mini SD card 20 as shown in FIG. 4. In addition, a metal terminal 14 is located on the casing 11 at a position corresponding to an interior of the slot 13, to make a connection with a metallic conduction part 22 on the Mini SD card 20.

A groove 15 is located at an edge, which is corresponding to a top end of the casing 11, of the slot 13, and a stick 16 which is formed integrally with the casing 11 and extending from a front end to a rear end, is located in the groove 15, so as to create a state of elastic restoring to the stick 16 in the groove 15. A projection part 17 facing the slot 17 side is at a tail end of the stick 17.

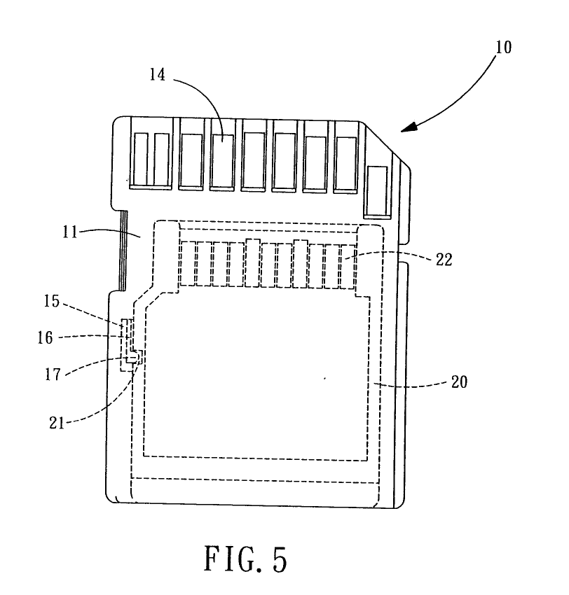

Referring to FIG. 5, when the Mini SD card 20 is being inserted on the adapter card 10, as a notch 21 is pre-installed at an edge of the Mini SD card 20, the Mini SD card 20 can be latched into the notch 21 by the projection part 17 at the tail end of the stick 16, and thus prevent from a fall-off of the Mini SD card 20, after inserting the Mini SD card 20 into the adapter card 10. In addition, as a state of elastic restoring can be created to the stick 16 in the groove 15, the Mini SD card 20 can be pulled out by a little force, so as to remove the projection part 17 from the notch 21 with a backward swing of the stick 16 driven by the projection part 17 upon pulling out the Mini SD card 20, thereby successfully taking out the Mini SD card 20. Moreover, the stick 16 can also be restored to a state prior to the action by the effect of elastic restoring.

It is worth to mention that the groove 15 and the stick 16 disclosed in the present invention are formed integrally by performing an injection molding process to the casing 10, and the state of elastic restoring can be created to the stick 16 in the groove 15, so as to quickly perform an insertion and pulling during inserting and pulling out the Mini SD card 20.

Moreover, the stick 16, which is formed integrally with the casing 11 by the process of injection molding, is used to replace a conventional extension arm made by a metallic material, which not only can improve a problem of easy to break off the metallic material during a manufacturing process, but also can increase a perfection rate and a productivity of the product, as well as largely reduce a manufacturing cost of the adapter card.

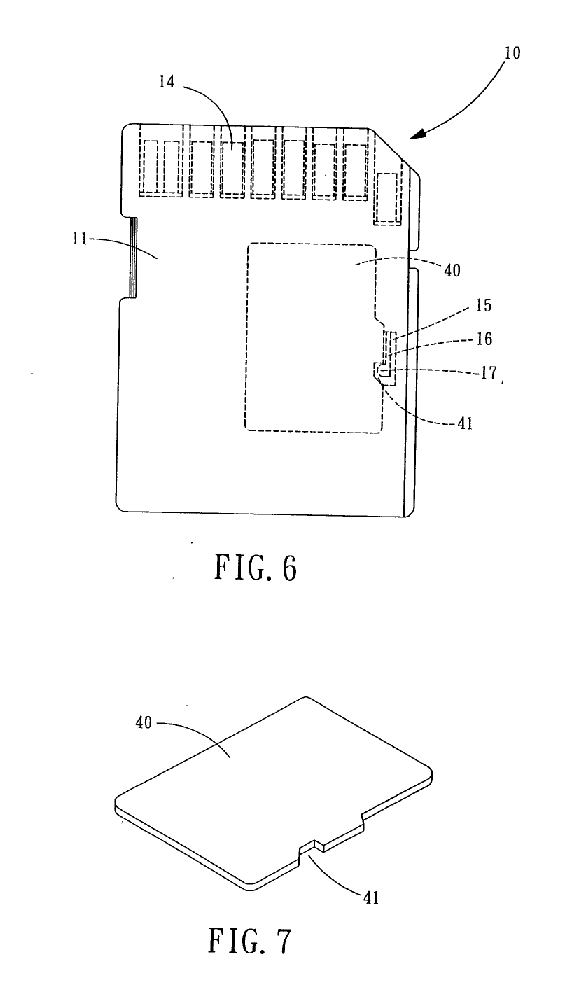

Accordingly, referring to FIG. 6 and FIG. 7, when a Micro SD card 40 is being inserted on the adapter card 10, as a notch 41 is pre-installed at an edge of the Micro SD card 40, the Micro SD card 40 can be latched into the notch 41 by the projection part 17 at the tail end of the stick 16, and thus prevent from a fall-off of the Micro SD card 40, after inserting the Micro SD card 40 into the adapter card 10. In addition, as a state of elastic restoring can be created to the stick 16 in the groove 15, the Micro SD card 40 can be pulled out by a little force, so as to remove the projection part 17 from the notch 21 with a backward swing of the stick 16 driven by the projection part 17 upon pulling out the Micro SD card 40, thereby successfully taking out the Micro SD card 40. Moreover, the stick 16 can also be restored to a state prior to the action by the effect of elastic restoring.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An adapter card structure comprising primarily a casing and a cover, wherein the cover is covered on a top of the casing in order to form a slot with the casing for inserting a memory card, and a metal terminal is located on the casing at a position corresponding to an interior of the slot, so as to make a connection with a metallic conduction part on the memory card to be inserted; a groove being located at an edge of the slot corresponding to a top end of the casing, and a stick extended from a front end to a rear end being located in the groove, so as to create a state of elastic restoring to the stick in the groove; a projection part facing the slot side being located at a tail end of the stick, which can be latched into a notch at an edge of the memory card to prevent a fall-off of the memory card.

2. The adapter card structure according to claim 1, wherein the stick and the casing are formed integrally by an injection molding process.

3. The adapter card according to claim 1, wherein the memory card to be inserted can be a memory card of a Mini SD specification.

4. The adapter card structure according to claim 1, wherein the memory card to be inserted can be a memory card of a Micro SD specification.

5. The adapter card structure according to claim 1, wherein for the adapter card used for inserting the Mini SD card, the stick and projection part are located at a left side of the slot.

6. The adapter card structure according to claim 3, wherein for the adapter card used for inserting the Mini SD card, the stick and projection part are located at a left side of the slot.

7. The adapter card structure according to claim 1, wherein for the adapter card used for inserting the Micro SD card, the stick and projection part are located at a right side of the slot.

8. The adapter card structure according to claim 4, wherein for the adapter card Used for inserting the Micro SD card, the stick and projection part are located at a right side of the slot.
